(19) United States
(12) Patent Application Publication
(10) Pub. No.: US 2010/0012665 A1
(43) Pub. Date: Jan. 21, 2010

(54) Container having vortex breaker and fluid diverter and system

(75) Inventors: Martin Morrissey, Beverly, MA (US); James E. Kelly, JR., Melrose, MA (US); Dennis Wong, Dedham, MA (US); Steve Mello, Bradford, MA (US); Jean-Louis Weissenbach, Barr (FR)

Correspondence Address: MILLIPORE CORPORATION, 290 CONCORD ROAD, BILLERICA, MA, 01821, US

(73) Assignee: Millipore Corporation, Billerica, MA (US)

(21) Appl. No.: 12/454,441

(22) Filed: May 18, 2009

Related U.S. Application Data
(60) Provisional application No. 61/130,358, filed on May 30, 2008.

(51) Int. Cl. B65D 6/40; B01D 21/26

(52) U.S. Cl. 220/601; 210/512.1

(57) ABSTRACT

A disposable container for fluid is provided. The container has a vortex breaker positioned adjacent the container outlet and a fluid diverter positioned adjacent each inlet to the container.

### CROSS-REFERENCED TO RELATED APPLICATIONS

This application claims the benefit of U.S. Provisional Patent Application No. 61/130,358, filed on May 30, 2008, the entire contents of which are incorporated by reference herein.

### FIELD OF THE INVENTION

This invention relates to a disposable container having a vortex breaker at its outlet and a fluid diverter at its inlet and to a system utilizing the container.

### BACKGROUND OF THE INVENTION

Prior to the present invention, fluids have been processed in systems that utilize stainless steel containers. These containers are sterilized after use so that they can be reused. The sterilization procedures are expensive and cumbersome as well as being ineffectual at times.

In order to provide greater flexibility in manufacturing and reduce the time needed to effect valid regeneration manufacturers have begun to utilize disposable sterilized bags that are used with each product batch. An example of use of these disposable bags is in a system for processing protein solutions wherein the protein in solution is concentrated by tangential flow filtration (TFF). Another example of use is in a system for changing the pH of a protein solution by exchanging buffer solutions. Utilizing TFF and by replacing the buffer in a protein solution with a new buffer. In each of these processes, the retentate is recirculated from the TFF step to the disposable bag. At low fluid levels in a TFF recirculation bag, there is a concern with the manner in which fluid enters the bag from the retentate return line. Ideally the fluid will not splash as it returns to the bag. Splashing causes foaming which is undesirable in this application. Another concern is that the incoming fluid will not mix well with the fluid already in the tank. If the returning fluid is not diverted as it returns, there is a danger that it will flow directly to the bag outlet and by-pass mixing with the fluid already in the bag. This situation is known as “short-circuiting”, and is an impediment to proper mixing of the process fluid. Another problem associated with the returning fluid, is that it can create a fountain that will splash and cause foaming.

Another problem occurs at the bag outlet where the fluid is removed from the bag. When the fluid is removed, one or more conical shaped vortices are formed from a conical column of gas present in the bag. This is undesirable since the vortex will cause mixing of the fluid with gas which results in undesirable foaming.

According, it would be desirable to provide a disposable container for fluids having means for minimizing or preventing foaming at the container inlet and at the container outlet. In addition, it would be desirable to provide such a container wherein fluid entering the inlet is directed away from the outlet thereby to effect mixing of the incoming fluid with the fluid in the container.

### SUMMARY OF THE INVENTION

A disposable container for a fluid having one or more inlets and an outlet is provided having a device for minimizing or preventing foaming of fluid at the outlet and at the one or more inlets. In addition, the container is provided with a flow diverter at the one or more inlets which direct fluid entering the container away from the outlet thereby to effect mixing of incoming fluid with fluid in the container.

A system is also provided that utilizes the container with a fluid treatment step such as a TFF unit whereby treated fluid is recycled to the container.

The one or more inlets are provided with a fluid diverter comprising a conduit having one or a plurality, usually two, open ends. The conduit is positioned adjacent each inlet and the open ends are positioned to direct fluid away from the outlet. The outlet is provided with a vortex breaker comprising a solid surface that initially directs fluid away from the outlet. Openings are provided adjacent the solid surface which permits fluid to enter the outlet. The initial direction of fluid away from the outlet minimizes or prevents the formation of one or more vortices at the outlet.

### BRIEF DESCRIPTION OF THE DRAWINGS

FIG. 1 is a schematic view of a system of this invention.

FIG. 2 is a schematic view of an alternative system of this invention.

FIG. 3 illustrates fluid flow at the inlet of the prior art container.

FIG. 4 illustrates the splashing problem of the prior art at the inlet of a prior art container.

FIG. 5 is a perspective view of a fluid diverter positioned adjacent an inlet of the container of this invention.

FIG. 6 is a perspective view of a vortex breaker positioned adjacent an outlet of the container of this invention.

FIG. 7 shows an alternative fluid diverter of this invention.

FIG. 8 shows an alternative fluid diverter of this invention.

FIG. 9 shows an alternative fluid diverter of this invention.

FIG. 10 shows an alternative fluid diverter of this invention.

FIG. 11 shows an alternative fluid diverter of this invention.

FIG. 12 shows an alternative fluid diverter of this invention.

FIG. 13 shows an alternative fluid diverter of this invention.

### DESCRIPTION OF SPECIFIC EMBODIMENTS

The disposable container of this invention is formed of monolayer or multilayer flexible walls formed of a polymeric composition such as polyethylene, including ultrahigh molecular weight polyethylene, linear low density polyethylene, low density or medium density polyethylene; polyproplylene; ethylene vinyl acetate (EVOH); polyvinyl chloride (PVC); polyvinyl acetate (PVA); ethylene vinyl acetate copolymers (EVA copolymers); blends of various thermoplastics; coextrusions of different thermoplastics; multilayered laminates of different thermoplastics; or the like. By “different” it is meant to include different polymer types such as polyetehylene layers with one or more layers of EVOH as well as the same polymer type but of different characteristics such as molecular weight linear or branched polymer of fillers and the like. Typically medical grade and preferably animal-free plastics are used. They generally are sterilizable such as by steam, ethylene oxide or radiation such as beta or gamma radiation. Most have good tensile strength, low gas transfer and are either transparent or at least translucent. The container is provided with one or more inlets, an outlet and an optional vent passage. As set forth above, each inlet is provided with a fluid diverter which is secured to the inside wall of the container such as by heat sealing or with an adhesive and positioned adjacent each inlet. Optionally, the fluid diverter can be molded into the inlet structure.

The outlet is provided with a vortex breaker positioned adjacent the outlet and secured to the inside surface of the container such as by heat sealing or with an adhesive. Optionally, the vortex breaker can be molded into the outlet structure.

In a preferred embodiment, the disposable container is positioned within a solid support container for ease of filling and emptying the container of fluid.

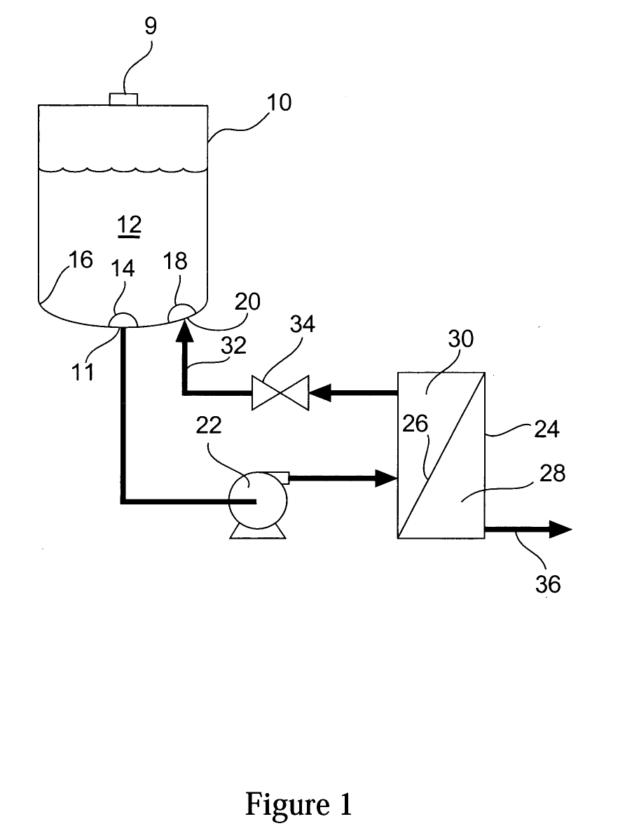

Referring to FIG. 1, the container of this invention 10 containing fluid 12 includes a vortex breaker 14 secured to the inner surface 16 of the container 10 at outlet 11 and a fluid diverter 18 secured to the inner surface 16 of the container 10 at the inlet 20 and, optionally, a vent 9. A pump 22 is provided to direct the fluid 12 through the outlet 11 to a downstream unit such as a TFF unit 24 as shown. The TFF unit 24 is provided with a membrane such as an ultrafiltration or microporous membrane 26. The membrane 26 separates fluid 12 into a filtrate 28 and a retentate 30. The retentate 30 is recycled to container 10 through conduit 32 when valve 34 is open, through inlet 20 located through the bottom surface of container 10. The filtrate 28 is directed through conduit 36 to a point of use or to be discarded. By operating in this manner, a portion of the fluid 12 in the retentate such as protein is concentrated in the container 10.

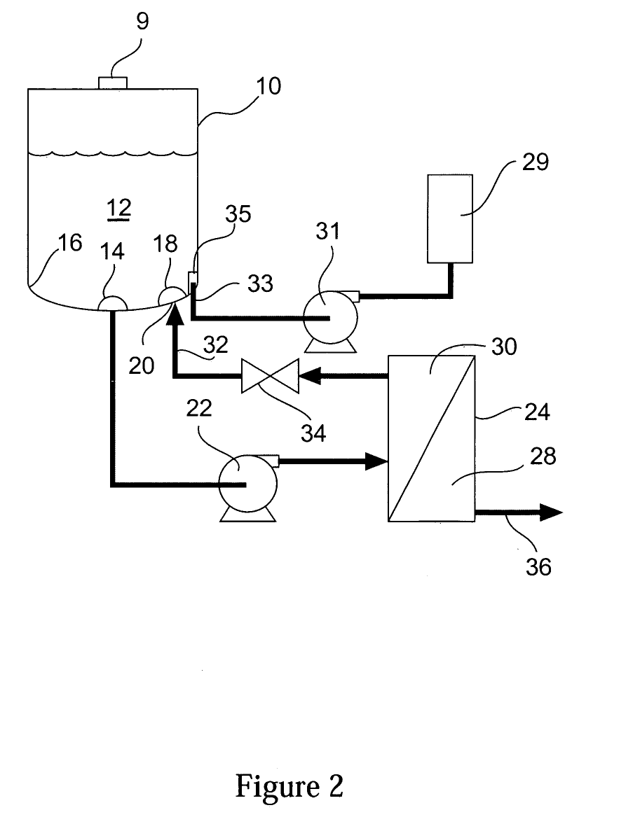

Referring to FIG. 2 where like reference numbers as the reference number in FIG. 1 refer to the same elements. The container of this invention 10 containing fluid 12 includes a vortex breaker 14 secured to the inner surface 16 of the container 10 at outlet 11 and a fluid diverter 18 secured to the inner surface 16 of the container 10 at the inlet 20 and, optionally, vent 9. A pump 22 is provided to direct the fluid 12 through the outlet 11 to an operation unit, such as the TFF unit 24 as shown. The TFF unit 24 is provided with a membrane such as an ultrafiltration or microporous membrane 26. The membrane 26 separates fluid 12 into a filtrate 28 and a retentate 30. The retentate 30 is recycled to container 10 through conduit 32 when valve 34 is open, through inlet 20. The filtrate 28 is directed through conduit 36 to a point of use or to be discarded. By operating in this manner, a portion of the fluid 12 in the retentate such as protein is concentrated in the container 10. A second container 29 is provided and contains, for example, a second buffer. The second buffer is directed to container 10 by pump 31 through inlet 33 which is provided with fluid diverter 35. The second buffer mixes with the first buffer in the fluid within container 10. By multiple recycling in the TFF unit 24, the second buffer substantially replaces the first buffer over time thereby to change the pH ionic strength or salt or the like of the fluid in container 10.

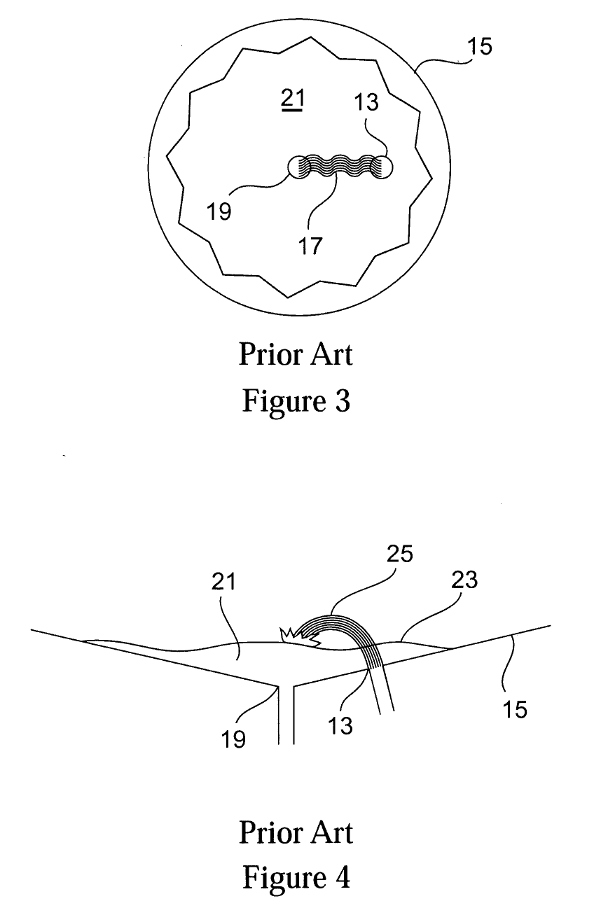

Referring to FIG. 3, a problem of the prior art container is illustrated. The prior art lacks a flow diverter. In operation, a fluid enters inlet 13 of container 15 and follows path 17 directly to outlet 19 rather than mixing with fluid 21 in container 15. This mode of operation is undesirable since it leads to non-uniform fluid compositions.

Referring to FIG. 4, a second problem of the prior art is illustrated. When the fluid level is low in container 15, fluid entering inlet 13 can break the surface 23 of fluid in the container 15 to form stream 25. Stream 25 then contacts the surface 23 to splash fluid, thereby promoting undesirable foaming.

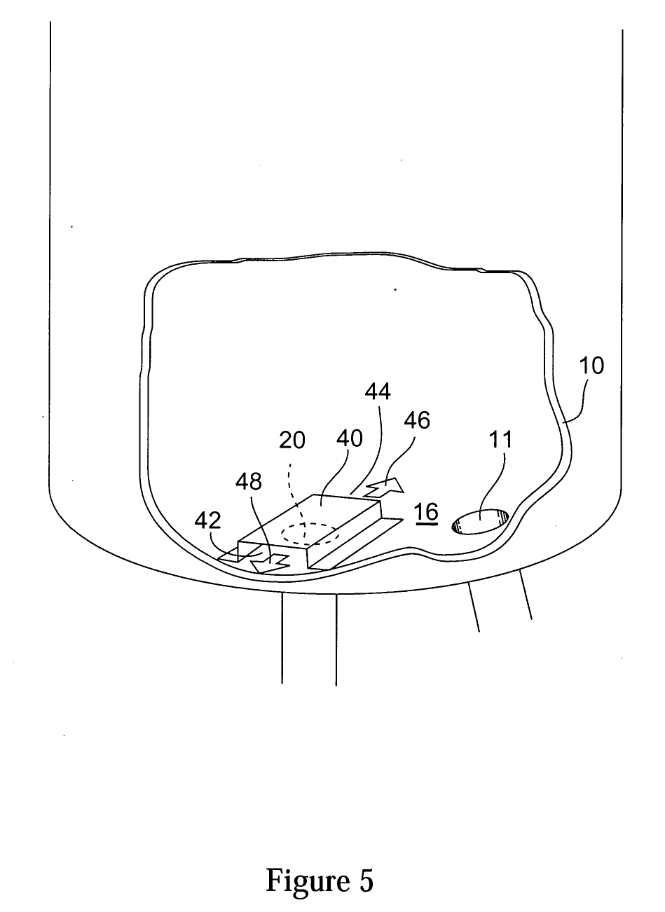

Referring to FIG. 5, the fluid diverter 40 of this invention is shown. The fluid diverter 10 is sealed to the inner wall 16 of container 10. The fluid diverter 40 comprises a conduit positioned over inlet 20. The diverter 40 has two open ends 42 and 44 so that fluid entering inlet 20 are directed away from outlet 11 as represented by arrows 46 and 48. This structure promotes desired mixing of fluid entering inlet 20 with fluid in container 10.

Optionally, the diverter 40 may have one open end or more than two open ends depending on the design of the diverter. For example, in using a square or rectangular design, as shown, one can use two open ends 42, 44 as shown. Alternatively, one can elect to have just one open end 42 and seal the other normally open end 44.

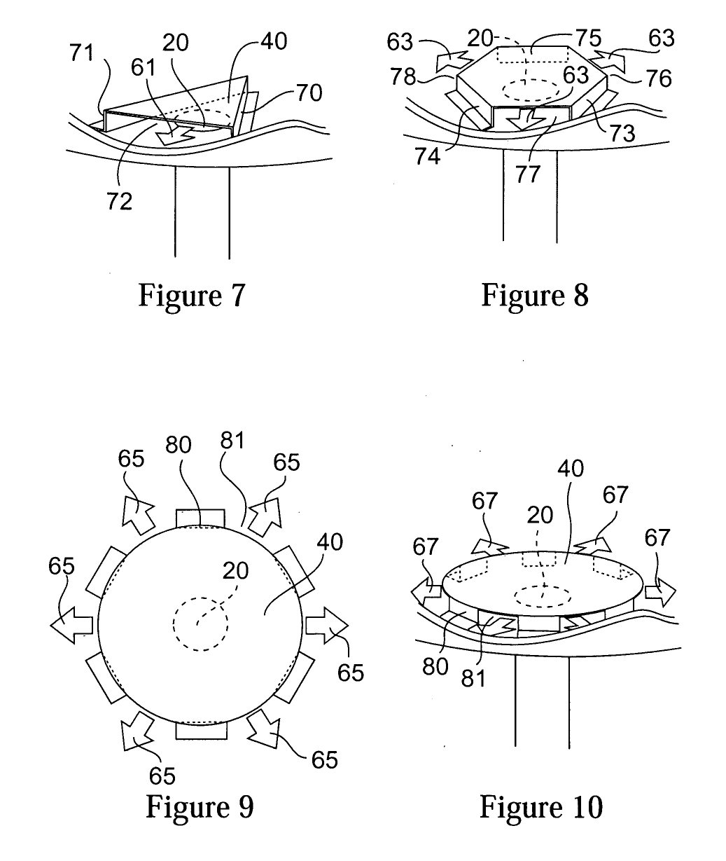

Moreover, when one uses a triangular-shaped diverter 40 (FIG. 7) one can have two sealed ends 70, 71 and one open end 72 through which fluid occurs as represented by arrow 61.

Using a polygonal shape of more than four sides, such as the hexagonal-shaped diverter 40 of FIG. 8, one can have 3 or more open ends 76, 77, 78 through which fluid flow occurs as represented by arrows 63 or closed ends 73, 74, 75.

Additionally, one can use a circular-shaped diverter 40 (FIG. 9) or oval-shaped diverter 40 (FIG. 10) and vary the number of openings 81 and closings 80 as desired to provide effective flow and diversion without undue pressure increases to effect fluid flow as represented by arrows 65 and 67.

While shown as having symmetrically arranged openings, they do not necessarily have to be so and can be tailored to provide one with the desired fluid flow.

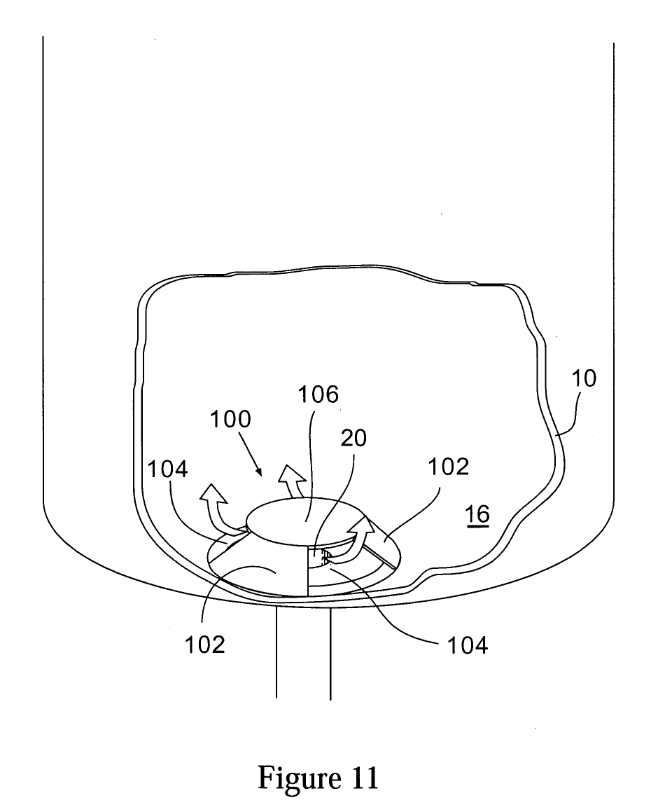

Likewise one can use a solid diverter 100 that is either attached to the port 20 or formed as part of the port 20 as shown in FIG. 11. The diverter 100 has one or more openings 104 and one or more solid closed portions 102 and a closed top 106. Fluid entering the diverter 100 flows out of the openings 104 but not the closed portions 102 so as to prevent the fluid from going directly to the outlet.

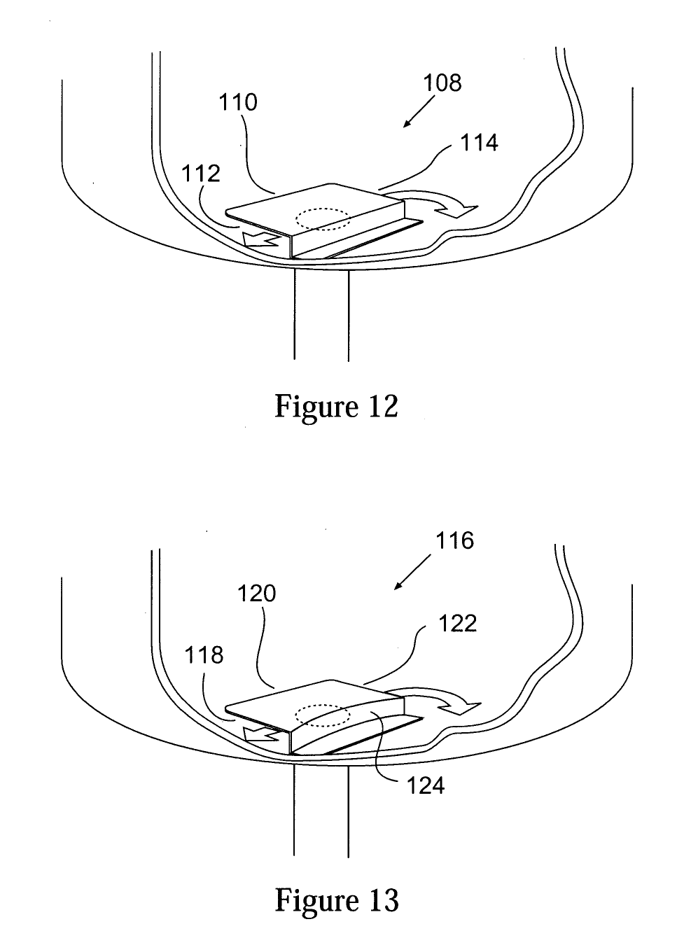

As shown in FIG. 12, a diverter 108 comprises a stepped diverter having three openings 110, 112 and 114.

As shown in FIG. 13, a diverter 116 comprises a stepped diverter comprising three openings and a curved surface 124. The curved surface promotes drainability of fluid from a container of this invention.

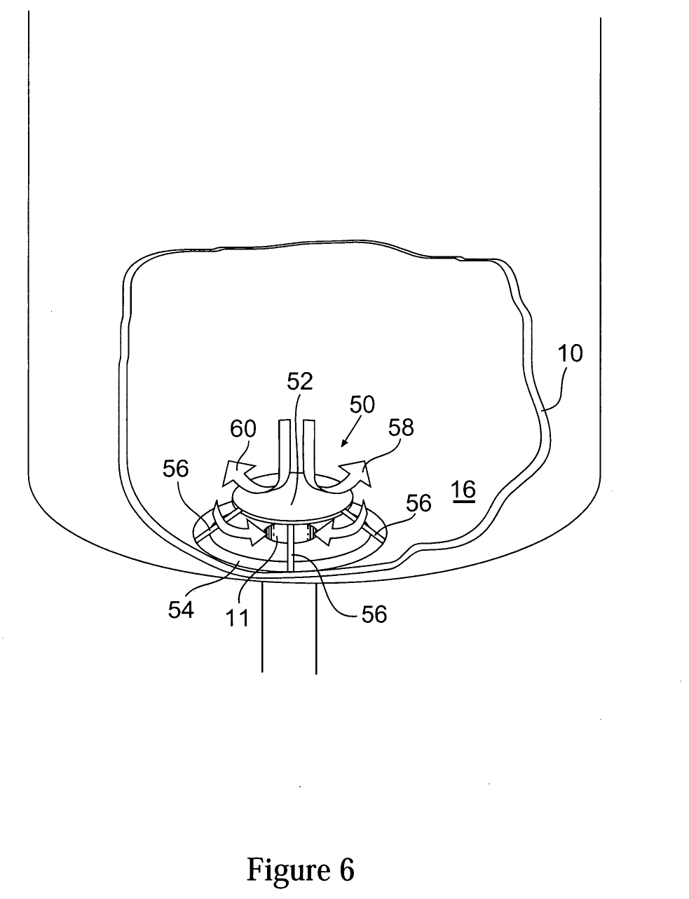

Referring to FIG. 6, a vortex breaker 50 of this invention is shown. The vortex breaker comprises a solid surface 52 that can be any shape including circular, as shown or polygonal. The base 54 is sealed to the inner wall 16 of container 10. The vortex breaker 50 is positioned adjacent outlet 11. The solid surface 52 is supported by supports 56 attached to solid surface 52 and base 54. The vortex breaker 50 initially causes fluid to be directed away from outlet 11 as indicated by arrows 58 and 60 and then is directed to outlet 11 through the spaces between supports 56. By operating with this vortex breaker, formation of vortices is minimized or prevented.

As with the diverter, the vortex breaker may also be formed as part of the outlet 11.

What is claimed:

1. A disposable container for a fluid which comprises:
a closed volume formed of flexible walls,
one or a plurality of inlets through said walls,
an outlet through said walls,
a fluid diverter positioned adjacent each of said inlets and secured to an inner surface of said walls, said fluid diverter adapted to direct fluid entering said one or more inlets away from said outlet,
and a vortex breaker positioned adjacent said outlet and secured to an inner surface of said walls, said vortex breaker adapted to direct fluid initially away from said outlet and then through said outlet.

2. The container of claim 1 having a vent.

3. A fluid processing system which comprises:
the container of claims 1,
a tangential flow filtration unit and
conduits to effect flow from said container to said tangential flow filtration unit and back to said container.

4. A fluid processing system which comprises:
the container of claims 2,
a tangential flow filtration unit and
conduits to effect flow from said container to said tangential flow filtration unit and back to said container.

5. The system if claim 3 which further includes a second container for a second fluid and means for directing and second fluid into said container through a second inlet,
said second inlet having a flow diverter positioned adjacent said second inlet and secured to an inner wall of said container.

6. The container of claim 1 wherein said flow diverter comprises a conduit having two open ends.

7. The container of claim 2 wherein said flow diverter comprises a conduit having two open ends.

8. The system of claim 3 wherein said flow diverter comprises a conduit having two open ends.

9. The system of claim 4 wherein said flow diverter comprises a conduit having two open ends.

10. The system of claim 5 wherein said flow diverter comprises a conduit having two open ends.

11. The container of claim 1 wherein said vortex breaker comprises a solid surface secured to a base by spaced apart solid supports.

12. The container of claim 2 wherein said vortex breaker comprises a solid surface secured to a base by spaced apart solid supports.

13. The system of claim 3 wherein said vortex breaker comprises a solid surface secured to a base by spaced apart solid supports.

14. The system of claim 4 wherein said vortex breaker comprises a solid surface secured to a base by spaced apart solid supports.

15. The system of claim 5 wherein said vortex breaker comprises a solid surface secured to a base by spaced apart solid supports.

16. The system of claim 1 wherein said fluid diverter comprises a conduit having at least one open end.

17. The system of claim 1 wherein said fluid diverter comprises a conduit having at least one open end and wherein the number of open ends is greater than two.

18. The system of claim 1 wherein said fluid diverter comprises a conduit having at least one open end and wherein the number of open ends is greater than three.
